(19) United States
(12) Patent Application Publication
(10) Pub. No.: US 2023/0182104 A1
(43) Pub. Date: Jun. 15, 2023

(54) Systems and Methods for Nitrogen Fixation

(71) Applicant: Soane Technologies, LLC, Miami, FL (US)

(72) Inventor: David S. Soane, Coral Gables, FL (US)

(21) Appl. No.: 18/080,023

(22) Filed: Dec. 13, 2022

Related U.S. Application Data
(60) Provisional application No. 63/288,886, filed on Dec. 13, 2021.
(60) Provisional application No. 63/347,664, filed on Jun. 1, 2022.

(51) Int. Cl. B01J 19/08; B01J 19/12; C01C 1/04; C01B 21/38

(52) U.S. Cl. CPC B01J 19/088; B01J 19/126; C01C 1/0494; C01B 21/38; B01J 2219/0896; B01J 2219/0869; B01J 2219/0875; B01J 2219/0884

(57) ABSTRACT

The invention includes a system for producing a nitrogen fixation product, where the system includes a nitrogen gas source providing nitrogen gas; a delivery system for the nitrogen gas in fluid communication with the nitrogen gas source, wherein the delivery system delivers the nitrogen gas into a plasma reactor, and wherein the plasma reactor energizes the nitrogen gas as a plasma to produce activated nitrogen species; a secondary reactant source providing a secondary reactant in a secondary reactant stream that is separated from the nitrogen gas, wherein the secondary reactant stream is directed to contact the activated nitrogen species in a reaction zone, and wherein contact between the activated nitrogen species and the secondary reactant produces a reaction that yields the nitrogen fixation product. The invention also includes methods of the use of such a system for producing a nitrogen fixation product.

### RELATED APPLICATIONS

This application claims the benefit of U.S. Provisional Application No. 63/288,886 filed Dec. 13, 2021 and U.S. Provisional Application No. 63/347,664 filed Jun. 1, 2022. The entire teachings of the above applications are incorporated herein by reference.

### FIELD OF THE APPLICATION

This application relates to systems and methods using plasma technology for nitrogen fixation.

### BACKGROUND

While nitrogen forms 78% of the Earth's atmosphere, it exists in a gaseous molecular form that is virtually unavailable for chemical or biological uses. It's extremely stable N—N triple-bond configuration demands an unusually high activation energy, rendering it unreactive under standard temperature and pressure conditions. To become usable, molecular nitrogen must be bonded to other chemicals such as oxygen or hydrogen. As used herein, those natural or industrial processes that combine very stable dinitrogen molecules (N₂) with other elements to form nitrogen-containing compounds such as ammonia, nitrates, or nitrites, are termed nitrogen fixation. In nature, soil microorganisms are responsible for over 90% of nitrogen fixation, combining nitrogen gas in the atmosphere with hydrogen or oxygen to form ammonia, nitrates, and nitrites; lightning can also energize nitrogen in the atmosphere sufficiently that it combines with oxygen to form NOx. Industrial processes are commonly employed to fix nitrogen into more usable and reactive compounds. Examples are the Haber-Bosch process for forming ammonia and the Ostwald process for forming nitric oxide from ammonia such as is produced by the Haber-Bosch process.

The development of the Haber-Bosch (HB) process unlocked the use of these very stable dinitrogen molecules by converting them from an inert gaseous form to a chemically reactive compound, ammonia. The HB process thereby revolutionized agriculture, allowing unreactive nitrogen to be captured in a biologically available form to be used as fertilizers. Since then, ammonia formed by the HB process has become the major feedstock for fertilizer synthesis. For example, ammonia can be used to make nitric acid, from which nitrate fertilizers can be produced; ammonia can also be mixed with liquid CO₂ to form urea for fertilizers; urea and ammonium nitrate can be combined to form urea ammonium nitrate fertilizers.

The availability of nitrogen fertilizers enabled by the HB process has dramatically increased agricultural productivity worldwide. It has been estimated that, by the beginning of the twenty-first century, nitrogen fertilizers have become responsible for feeding nearly half of the world's population. The HB process has been the key to the widespread use of nitrogen fertilizers: in 2000, about 99% of the total global production of ammonia (the feedstock for fertilizers) was estimated to be derived from the HB process.

While the availability of chemically active (and bioactive) nitrogen as found in fertilizers remains crucial to human food security, its production via the HB process imposes significant burdens on the environment. The HB process forms ammonia from atmospheric nitrogen through an exothermic, reversible reaction of chemical nitrogen fixation EQ1:

N₂+3H₂→2NH₃ EQ1

The reaction conditions for HB include temperatures between 400-600° C., and pressures between 200-400 atm. These conditions require considerable energy to produce and maintain. Energy requirements of this magnitude exceed the deployable scale for renewable energy sources, so that conventional (hydrocarbon-derived) energy is required to power HB facilities. It is estimated that the HB process worldwide consumes about 2% of the world's total energy production, uses about 2% of the world's natural gas output, and emits 300 million metric tons of CO₂ annually: about 1.87 tons of CO₂ is released per ton of ammonia produced. Furthermore, due to the extreme conditions required by the HB process, this method of ammonia synthesis is only practical in large installations where massive capital investments can be offset by large volumes of materials processed over a long reactor service life.

Alternatives to HB have been proposed and tried. Non-thermal plasma has been investigated as an alternative approach, in hopes of combining nitrogen and hydrogen in a plasma to form ammonia at a lower temperature and pressure than HB, without concomitant production of CO₂. However, these processes, using a mixture of nitrogen and hydrogen as a feedgas for the non-thermal plasma, have yielded only a low observed conversion of nitrogen to ammonia, and low efficiency; such procedures to date have not been viable for scale-up. Regardless of the mechanism for initiating and sustaining the plasma (e.g., arc, DC, RF, DBD, microwave), this technology has not been successful as a method for synthesizing ammonia from nitrogen and hydrogen.

Some versions of non-thermal plasma methods have used catalysts to effect the conversion of the nitrogen-hydrogen mixture to ammonia, but the catalysts themselves have technical limitations. Major impediments to the use of non-thermal plasma for nitrogen fixation include a requirement for more active catalysts than those familiar in the art, and the need to prevent undesirable back reactions that result in product decomposition (such as the back-reaction of EQ. 1), so that any ammonia produced has to be separated rapidly from the system before it can decompose. Despite the promise of non-thermal plasma as a less environmentally stressful energy source, it has not been used successfully to replace the HB process for ammonia synthesis. There remains a need in the art, therefore, for an industrial process of nitrogen fixation that can be carried out at moderate temperatures and pressures, consuming less energy, producing less carbon dioxide, and requiring less expensive infrastructure than the industry standard HB process.

There are further needs for alternatives to other processes involving nitrogen fixation reactions. For example, nitric acid is an industrially important chemical that is used to make fertilizers, for introducing nitro groups into organic syntheses, and for other similar purposes. Nitric oxide is predominately made from ammonia, typically produced using the Haber-Bosch process as described above. This route, converting ammonia into nitric acid, is termed the Ostwald process, and it involves three steps. The first step in the Ostwald process is the catalytic oxidation of ammonia by molecular oxygen to produce nitrogen monoxide. This step is followed by further oxidation of nitrogen monoxide to nitrogen dioxide. The nitrogen dioxide is finally absorbed by water to produce nitric acid. Formation of nitric oxide via the Ostwald process thus depends on the Haber-Bosch process for producing ammonia; furthermore, it introduces additional inefficiencies by requiring additional steps to generate the nitric oxide from the ammonia feedstock. Alternatives to the Ostwald process have been proposed, such as the Birkeland-Eyde process, but these have been too inefficient to be commercially successful. There remains a need in the art for an industrial process for producing nitric oxide that avoids a dependency on ammonia produced by Haber-Bosch, and that further avoids the uneconomical multi-step synthetic route that the Ostwald process entails.

### BRIEF DESCRIPTION OF FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing features of a conventional, prior art dielectric barrier discharge system.

FIG. 2 is a block diagram showing features of a nitrogen-fixation system as disclosed herein.

FIGS. 3A and 3B are schematic diagrams (cross-sectional and longitudinal projections) of an embodiment of a nitrogen fixation system.

FIG. 4 is a schematic cross-sectional diagram of an embodiment of a nitrogen fixation system.

FIG. 5 is a schematic diagram of an embodiment of a nitrogen fixation system in which a flow of nitrogen gas is directed into a plurality of high-energy regions.

FIG. 6 is a schematic diagram of an embodiment of a nitrogen fixation system.

### SUMMARY OF THE INVENTION

Disclosed herein, in embodiments, are systems for producing a chemical reaction product comprising: a primary gas source providing nitrogen gas; a delivery system in fluid communication with the primary gas source, wherein the delivery system delivers the nitrogen gas into a plasma reactor, wherein the plasma reactor energizes the nitrogen gas as a plasma to produce activated nitrogen species, and wherein the activated nitrogen species is emitted from the plasma into a reaction region peripheral to the plasma; a secondary reactant source providing a secondary reactant; and a conduit in fluid communication with the secondary reactant source, wherein the conduit directs the secondary reactant to contact the activated nitrogen species in the reaction region, and wherein contact between the activated nitrogen species and the secondary reactant in the reaction region produces the chemical reaction product. In embodiments, the plasma reactor comprises a dielectric barrier discharge system. In embodiments, the plasma reactor is formed as a cylinder having an inlet at its proximal end in fluid communication with the delivery system and an outlet at its distal end in fluid communication with the conduit, and wherein the nitrogen gas enters the inlet, is converted to the plasma within the plasma reactor, and exits through the outlet as activated nitrogen species to enter the reaction region. In embodiments, the conduit can be an external cylinder that surrounds the plasma reactor. In embodiments, the plasma is a non-thermal plasma. In embodiments, the activated nitrogen species passes through pores in the plasma reactor to enter the reaction region to contact the secondary reactant therein. In embodiments, the secondary reactant is a hydrogen source compound, which can be a liquid, and/or which can be an aliphatic compound; if a liquid, it can be dispensed as an aerosol to contact the activated nitrogen species. In embodiments, the hydrogen source compound consists essentially of diatomic hydrogen. In embodiments, the secondary reactant can be an oxygen source compound, which can consist essentially of diatomic oxygen. In embodiments, the secondary reactant comprises a non-oxygen heteroatom, which can be sulfur. In embodiments, the secondary reactant is a complex secondary reactant. In embodiments, the secondary reactant is energized separately and delivered to the reaction area in an activated state. In embodiments, the conduit is a planar structure. In embodiments, the chemical reaction product can be ammonia or an amine. In embodiments, the chemical reaction product comprises NOₓ species. In embodiments, the chemical reaction product is entrained in an effluent fluid stream, wherein the effluent fluid stream conducts the chemical reaction product away from the reaction region. In embodiments, the effluent stream is a gaseous stream, and the effluent stream can comprise a gas phase and a liquid phase. In embodiments, the system further comprises a separator in fluid communication with the effluent stream that separates the chemical reaction product from the effluent stream, and the separator can use a technique selected from the group consisting of liquefaction, cryogenic condensation, adsorption, and membrane separation.

Also disclosed, in embodiments, are systems for producing a chemical reaction product, comprising a nitrogen gas source providing nitrogen gas; a delivery system for the nitrogen gas in fluid communication with the nitrogen gas source, wherein the delivery system delivers the nitrogen gas into a plasma reactor, and wherein the plasma reactor energizes the nitrogen gas as a plasma to produce activated nitrogen species; a secondary reactant source providing a secondary reactant; a conduit in fluid communication with the secondary reactant source, wherein the conduit directs the secondary reactant to contact the activated nitrogen species, wherein contact between the activated nitrogen species and the secondary reactant produces the chemical reaction product, and wherein the chemical reaction product is entrained in an effluent fluid stream. In embodiments, the plasma reactor comprises a dielectric barrier discharge system. In embodiments, the plasma reactor is formed as a cylinder having an inlet at its proximal end in fluid communication with the delivery system and an outlet at its distal end in fluid communication with the conduit, and wherein the nitrogen gas enters the inlet, is converted to the plasma within the plasma reactor, and exits through the outlet as activated nitrogen species, and the conduit can be an external cylinder that surrounds the plasma reactor. In embodiments, the secondary reactant comprises hydrogen or is a hydrogen source compound, which can be a liquid, and/or which can be an aliphatic compound; if a liquid, it can be sprayed as an aerosol to contact the activated nitrogen species. In embodiments, the secondary reactant comprises oxygen or sulfur. In embodiments, the conduit is a planar structure. In embodiments, the activated nitrogen species passes through pores in the plasma reactor to contact the secondary reactant. In embodiments, the chemical reaction product can be ammonia or an amine. In embodiments, the effluent stream is a gaseous stream, and the effluent stream can comprise a gas phase and a liquid phase. In embodiments, the system further comprises a separator in fluid communication with the effluent stream that separates the chemical reaction product from the effluent stream, and the separator can perform a technique selected from the group consisting of liquefaction, cryogenic condensation, adsorption, and membrane separation.

Further disclosed, in embodiments, are methods of reacting nitrogen gas and a secondary reactant to form a reaction product, comprising: providing a nitrogen gas source, providing a secondary reactant source, and providing a plasma reactor; directing nitrogen gas from the nitrogen gas source to enter the plasma reactor; energizing the nitrogen gas within the plasma reactor to form a plasma that produces activated nitrogen species; conducting the activated nitrogen species to a reaction region peripheral to the plasma; and directing a secondary reactant from the secondary reactant source to interact with the activated nitrogen species in the reaction region, thereby forming the reaction product in the reaction region. In embodiments, the secondary reactant is energized in a separate plasma during the step of directing the secondary reactant from the secondary reactant source, with energizing in the separate plasma taking place before the secondary reactant reaches the activated nitrogen species in the reaction region. In embodiments, the secondary reactant comprises hydrogen; in other embodiments, the secondary reactant consists essentially of diatomic hydrogen. In embodiments, the secondary reactant comprises oxygen; in other embodiments, the secondary reactant consists essentially of diatomic oxygen. In embodiments, the reaction product comprises NOₓ species, and the method can further comprise hydrating the NOₓ species to produce nitric acid. In embodiments, the method further comprises entraining the reaction product in a fluid stream to form a product stream, and directing the product stream away from the reaction region. In embodiments, the method further comprises separating the reaction product from the product stream, and the step of separating can use a technique selected from the group consisting of liquefaction, cryogenic condensation, adsorption, and membrane separation.

Further disclosed herein, in embodiments, are systems for producing a nitrogen fixation product, comprising a nitrogen gas source providing nitrogen gas; a delivery system for the nitrogen gas in fluid communication with the nitrogen gas source, wherein the delivery system delivers the nitrogen gas into a plasma reactor, and wherein the plasma reactor energizes the nitrogen gas as a plasma to produce activated nitrogen species; and a secondary reactant source providing a secondary reactant in a secondary reactant stream that is separated from the nitrogen gas, wherein the secondary reactant stream is directed to contact the activated nitrogen species in a reaction zone, and wherein contact between the activated nitrogen species and the secondary reactant in the reaction zone produces a reaction that yields the nitrogen fixation product. In embodiments, the plasma reactor forms a non-thermal plasma; the plasma reactor can comprise a dielectric barrier discharge system or a microwave discharge system.

In embodiments, the plasma reactor is formed as a cylinder having a proximal end and a distal end, and having an inlet at the proximal end in fluid communication with the delivery system and an outlet at the distal end in fluid communication with the reaction zone, and wherein the nitrogen gas enters the inlet, is converted to the activated nitrogen species within the plasma reactor, and exits through the outlet as activated nitrogen species to enter the reaction zone. In embodiments, the activated nitrogen species can pass through pores in the plasma reactor to enter the reaction zone to contact the secondary reactant therein. In embodiments, the secondary reactant is a hydrogen source compound, which can be hydrogen gas; the nitrogen fixation product can be ammonia. In other embodiments, the hydrogen source compound is an aliphatic compound, and the chemical reaction product can be an amine. In embodiments, the secondary reactant is an oxygen source compound, which can be diatomic oxygen, and the chemical reaction product can comprise NOₓ species. In other embodiments, the secondary reactant comprises a non-oxygen heteroatom, which can be sulfur. In yet other embodiments, the secondary reactant is a complex secondary reactant. In embodiments, the hydrogen source compound is a liquid, which can be is dispensed as an aerosol to contact the activated nitrogen species in the reaction zone.

In certain systems, the secondary reactant is energized separately and delivered to the reaction area in an activated state. In embodiments, the secondary reactant stream is directed through a conduit to contact the activated nitrogen species in the reaction zone. The conduit can be an external cylinder that surrounds the plasma reactor, or it can be a planar structure. In embodiments, the nitrogen fixation product exits the reaction zone in an effluent fluid stream, which can be a gaseous stream or which can comprise a gas phase and a liquid phase. The system can further comprise a separator in fluid communication with the effluent stream that separates the nitrogen fixation product from the effluent fluid stream, and the separator can perform a technique selected from the group consisting of liquefaction, cryogenic condensation, adsorption, and membrane separation to separate the nitrogen fixation product from the effluent fluid stream.

Further disclosed herein, in embodiments, are methods of reacting nitrogen gas and a differentially activated secondary reactant to form a nitrogen fixation product, comprising: providing a nitrogen gas source that produces a nitrogen gas stream comprising nitrogen gas and providing a secondary reactant source that produces a secondary reactant stream comprising a differentially activated secondary reactant, wherein the nitrogen gas stream and the secondary reactant stream are separated from each other; providing at least one plasma reactor; directing the nitrogen gas stream to enter the at least one plasma reactor while remaining separated from the secondary reactant stream; energizing the nitrogen gas within the at least one plasma reactor to form activated nitrogen species, wherein the nitrogen gas and the activated nitrogen species remain separated from the secondary reactant stream; entraining the activated nitrogen species in an activated nitrogen stream; directing the activated nitrogen stream to exit the at least one plasma reactor to enter a reaction zone as an activated nitrogen stream comprising the activated nitrogen species; and directing the secondary reactant stream to enter the reaction zone to interact with the activated nitrogen species in the reaction zone, wherein the activated nitrogen species reacts with the differentially activated secondary reactant in the reaction zone, thereby forming the nitrogen fixation product. In embodiments, the differentially activated secondary reactant is not activated. In other embodiments, the differentially activated secondary reactant is activated in a second plasma reactor prior to the step of directing the secondary reactant stream to interact with the activated nitrogen species in the reaction zone. In embodiments, the differentially activated secondary reactant consists essentially of diatomic hydrogen, or comprises oxygen, or consists essentially of diatomic oxygen. In embodiments, the nitrogen fixation product comprises NOₓ species. In embodiments, the method further comprises hydrating the NOₓ species to produce nitric acid. In embodiments, the method further comprises a step of removing the nitrogen fixation product from the reaction zone in an effluent fluid stream. The effluent fluid stream can be a gaseous stream, or the effluent fluid stream can comprise a gas phase and a liquid phase. In embodiments, the method can further comprise a step of separating the nitrogen fixation product from the effluent stream, and the step can employ a separation technique selected from the group consisting of liquefaction, cryogenic condensation, adsorption, and membrane separation. In embodiments, the method further comprises a step of directing the effluent fluid stream away from the reaction zone before the step of separating the nitrogen fixation product from the effluent fluid stream.

Also disclosed herein, in embodiments, are methods for producing a nitrogen fixation reaction, comprising: providing a primary reactant stream comprising N₂; providing a secondary reactant stream comprising a hydrogen source reactant intended to react with the N₂ in the primary reactant stream; separating the primary and the secondary reactant streams and maintaining separation between them; activating the N₂ in a first plasma to form activated N₂; shielding the hydrogen source reactant from the first plasma to maintain the hydrogen source reactant in an differentially activated state; and recombining the activated N₂ with the hydrogen source reactant in the differentially activated state. In embodiments, the differentially activated state is an unactivated state.

### DETAILED DESCRIPTION

1. Split-Stream Plasma-Based Systems and Methods for Nitrogen Fixation Systems

It has been unexpectedly discovered that separating N₂ (the primary reactant) from any co-reactants (secondary reactants) and treating the primary reactant stream in its own plasma-based reaction system (apart from any secondary reactants) system can result in their successful combination in a designated reaction zone to accomplish nitrogen fixation. As used herein, the term “nitrogen fixation” refers to any process whereby molecular nitrogen (N₂) combines with other molecules (secondary reactants) to form nitrogen-containing compounds, whether by oxidation or by reduction of the N₂. Such desired reaction products of nitrogen fixation are considered to be the higher-value chemical products of the reactions. This reaction sequence, with the initial activation of the primary reactant and the secondary combination with the unactivated or separately activated reactant in the designated reactant region, triggering a cascade of combination/rearrangement reactions that lead to the combination of the secondary reactant with the N₂ species activated by the plasma to produce nitrogen fixation products with good yield, selectivity, and energy efficiency.

Non-thermal plasmas can be harnessed advantageously for these purposes, especially for those reactions intended to form ammonia from nitrogen as the primary reactant and hydrogen as the secondary reactant. As used herein, the term “primary reactant” refers to the reactant (here N₂) being activated in the plasma-based system to interact with and effect an intended reaction with a separate compound that is used as a substrate for the reaction with the primary reactant. As used herein, the term “secondary reactant” refers to those secondary species that are presented for reaction with the nitrogen that has been activated by the plasma, wherein the reaction of the nitrogen reactant with the secondary reactant results in fixation of nitrogen on the secondary reactant molecule to produce the desired products. As used herein, the term “activated” includes, without limitation, those vibrationally excited, electronically excited, and dissociated species originating from N₂ due to energy transfer from the plasma; it is recognized that activation can also be performed using other energy sources besides those involved in the formation of plasma, such as thermal energy or other conventional sources. The present invention focuses on activation as takes place in a plasma, preferably a non-thermal plasma (NTP), although such activation can be combined with other types of activation without departing from the principles of these systems and methods.

At its most basic level, a NTP is generated by placing two electrodes in a gas or gas mixture and creating an electrical potential difference between them. The potential difference can be created by direct current, alternating current, or current pulses. Energy to create a NTP can also be provided by other means, such as microwaves or induction coils. The electrons in the NTP attain a high average energy (1-10 eV) and reach a high average electron temperature (10,000-100,000 K), while the temperature in the gas itself remains low. The high electron energies and temperatures allow the dissociation and/or activation of the gas molecules in the plasma, so that they can rearrange and react to form other products. Plasma can activate nitrogen molecules by ionization, excitation, and dissociation, creating a cascade of reactive species (excited atoms, ions, radicals, and molecules) to propagate and initiate other chemical reactions.

A number of NTP techniques can be applied to activate nitrogen molecules, offering different electrode geometries, applied pressures, and plasma generation methods. For nitrogen fixation, the major NTP mechanisms are dielectric barrier discharge (DBD) systems, microwave (MW) discharge systems, and gliding arc (GA) discharge systems; other types of NTP for activation of nitrogen molecules can include, without limitation, radiofrequency (RF) discharge, corona discharge, glow discharge, and nanosecond pulse discharge.

Such a system, with separation of the two reactants and with selective plasma energization (i.e., activation) of only the N₂ (the primary reactant) or selective plasma energization of the N₂ and separate plasma energization of the secondary reactant is referred to herein as a “split-stream” plasma-based system. In either case, whether unactivated or whether activated differently than and separated from the primary reactant, the secondary reactant can be designated as “differentially activated,” to capture these two possibilities (i.e., activated not at all, or activated differently than but separately from the primary reactant). In the systems and methods disclosed herein, such split-stream systems with an activated primary reactant and a differentially activated secondary reactant can be used effectively for nitrogen fixation.

In embodiments, such systems can be used effectively for nitrogen fixation involving ammonia production, nitrogen oxide (NOₓ) products, or more complex products, depending on the choice of a secondary reactant. In accordance with these systems and methods, the primary reactant to be energized in the plasma is N₂. For the production of hydrazine, ammonia or amines the secondary reactant can be hydrogen alone, while for more complex products such as (without limitation) imines, nitriles, pyridines, or aziridines, a hydrogen source reactant can be used. As used herein, the terms “hydrogen source reactant” or “hydrogen source molecule” refers to a hydrocarbon or other molecule having one or more hydrogen atoms that can be exchanged with an activated nitrogen atom in a nitrogen fixation reaction, or that can react with the activated nitrogen atom to form more complex molecules comprising nitrogen and hydrogen. In other embodiments, the secondary reactant can be a heteroatom-containing molecule, such as oxygen or an oxygen source reactant, in which the heteroatom provides the site for nitrogen fixation. As used herein, the term “oxygen source reactant” refers to a molecule having one or more oxygen atoms that can be exchanged with an activated nitrogen atom in a nitrogen fixation reaction, or that can react with the activated nitrogen atom to form more complex molecules comprising nitrogen and oxygen. For example, oxygen or oxygen source molecules used as secondary reactants can then combine with the energized nitrogen species produced by the plasma, to yield various nitrogen oxide (NOₓ) molecules (e.g., nitric oxide, nitrogen dioxide, nitrous oxide, and the like), nitric acid or nitrous acid or their precursors, and other combinations of oxygen-containing molecules and nitrogen depending on the secondary reactant selected. Examples of functional groups that can be introduced via more complex secondary reactants include, without limitation, nitro, nitroso, oxime, amide, and cyanate groups. Secondary reactants can also include molecules comprising other heteroatoms that can combine with the activated nitrogen species to form desirable products. For example, a thiol or other organosulfur compound as a secondary reactant can combine with the activated nitrogen species to couple the nitrogen to the sulfur to make thiocyanates and isothiocyanates. In embodiments, secondary reactants can be complex, providing multiple and/or disparate sites for nitrogen fixation. For example, a complex secondary reactant can contain only hydrogen source reaction sites or oxygen source reaction sites, but can have multiple foci on the same molecule for nitrogen reaction. In other embodiments, a complex secondary reactant can have both hydrogen source moieties and oxygen source moieties on the same molecule; similarly, other heteroatoms can coexist on the same complex secondary reactant molecule with hydrogen or oxygen source moieties present as well.

The systems and methods disclosed herein are based on the surprising finding that separating the nitrogen from secondary reactants and activating the nitrogen reactant as the predominant component of a plasma allows the nitrogen to become sufficiently energized that it can then interact with the unactivated (i.e., in a non-plasma-treated state) or separately activated (i.e., in a separately plasma-treated state) secondary reactants, whether such secondary reactions are hydrogen or hydrogen source reactants, or oxygen or oxygen source reactants, or complex secondary reactants, or combinations thereof, including those carrying other heteroatoms, to accomplish nitrogen fixation. As used herein, the term “predominant component” of a plasma means that nitrogen can be used alone to form the plasma, or it can be combined with other molecules in the plasma as long as the nitrogen is present in sufficient quantities to absorb enough energy in the plasma to become activated. Stated equivalently, at a minimum, for the systems and methods disclosed herein nitrogen must be the predominant gas in a mixed feed in a plasma reactor, with the term “predominant” indicating that the N₂ is present in sufficient quantity that it is energized without “energy theft” from other molecules. As used herein, the term “energy theft” refers to the competitive absorption of energy by a more readily activated reactant in a plasma mixture, with the preferential energization of that reactant in the plasma instead of other co-present reactants; we may term this more readily-activated reactant an “energy thief” as compared to other reactants in the plasma mixture.

If nitrogen is the predominant component of a mixture being energized in a plasma, it has more reactivity in that plasma than any other component(s) of the mixture, and/or it is present in sufficiently large quantities within the plasma that the activated species of nitrogen are responsible for the intended reactions with the secondary reactant. Thus, even if the nitrogen is combined with other molecules in the plasma, the plasma's energy is preferentially concentrated on the nitrogen in the mixture instead of activating other components of the mixture; in the split-stream systems and methods disclosed herein, nitrogen is intentionally activated by the plasma, thereby producing activated nitrogen, and the secondary reactant is intentionally shielded from that activation. As used herein, the term “activated nitrogen” or “activated nitrogen species” includes, without limitation, those vibrationally excited, electronically excited, and dissociated species originating from nitrogen due to energy transfer from the plasma. If the nitrogen reactant is activated as the predominant component of a plasma, while the secondary reactant is deployed as a separate stream to encounter the activated nitrogen without itself being energized by the same plasma, this split-stream plasma-based approach avoids the problems of poor yield, low selectivity, and unfavorable energy efficiency encountered in previous plasma-based attempts at synthetic nitrogen fixation.

Disclosed herein are systems and methods for nitrogen fixation that are based on this discovery, including ammonia synthesis and nitric oxide systems. These systems and methods introduce two separate streams into a nitrogen fixation reactor, with the nitrogen stream being directed into a region of high field-intensity to create and sustain it as a plasma, while a secondary reactant, for example, hydrogen or a hydrogen source reactant, or oxygen or an oxygen source reactant is shielded from the exposure to high-field intensities. In these systems and methods, the nitrogen excited by the plasma emerges from the plasma zone to collide outside the plasma zone with the secondary reactant, for example, hydrogen or a hydrogen source molecule, triggering a cascade of combination/rearrangement reactions that ultimately lead to the interaction of the secondary reactant and the plasma-activated N₂ to convert the molecular nitrogen into the higher-value products. Alternatively, in some situations, the secondary reactant can be energized by a separate plasma as well, with each of the two separately energized reactants emerging from its plasma zone to collide with the other. The split-stream plasma-based system therefore allows the co-reaction of N₂ with an unlimited number of secondary reactants, as are described herein in more detail. Examples of hydrogen source molecules useful as secondary reactants include, without limitation, diatomic hydrogen and hydrocarbon compounds such as methane, other light/gaseous hydrocarbons, or other hydrogen sources including aliphatic or aromatic hydrocarbons, including without limitation alkanes or paraffins of various sizes and structures, such as methane (CH₄), ethane (C₂H₆, CH₃CH₃), propane (C₃H₈), butane (Gam); pentane (C₅H₁₂), hexane (C₆H₁₄), heptane (C₇H₁₆), octane (C₈H₁₈), C₉-C₁₆ alkanes, or heavier molecules, and unsaturated compounds such as alkenes and alkynes, and aromatics.

Nitrogen fixation products can form within these systems wherever the secondary reactant molecules encounter the activated nitrogen species produced by the plasma, whether within the less energized regions of the reactor itself, or external to the reactor as the activated nitrogen species exit the reactor. The area in which the activated nitrogen encounters the secondary reactant is termed the “reaction zone,” which is identified any area external to the energized portion of the plasma where the primary reactant (N₂) is being activated. The reaction zone is thus deemed to be peripheral to the plasma acting on the nitrogen, with the term “peripheral” encompassing any location that is outside of the energized portion of the plasma where the primary reactant is being activated. The reaction zone thus can be lateral to, external to, distal to, or otherwise outside of the energized portion of the plasma, allowing the nitrogen to be energized separately before it is combined with the secondary reactant. In embodiments, the secondary reactant can also be activated in a separate reactor, with the activated secondary reactant being directed to encounter the activated nitrogen species in a designated reaction zone.

After nitrogen fixation takes place, the resulting products can then be entrained in a fluid stream (i.e., liquid or gaseous) of effluents, which can include the desired chemical product(s), other reaction products, and unreacted nitrogen and secondary reactants. The desired chemical product(s), carried within the effluent fluid stream, can be transported away from the reaction zone within the effluent stream, and the effluent stream can undergo further separation using conventional separation techniques to isolate its various components, including the desired chemical product(s).

2. Nitrogen Fixation Reactions Using Activated Nitrogen and Selected Secondary Reactants

In more detail, nitrogen fixation in accordance with the systems and methods disclosed herein is initiated when a feedstock stream containing predominantly N₂ (the primary reactant) is fed through a plasma which energizes and creates activated nitrogen species. These species are rapidly brought into contact with a secondary reactant that is not exposed to plasma. The end result is the formation of desired nitrogen fixation products with improved energy efficiency because the plasma energy is focused on N₂ rather than on the secondary reactants. The reaction products being formed in the reaction zone are also protected from the plasma, preventing unwanted back reactions. As a modification, the secondary reactants can also be energized as necessary by a separate plasma. This setup enables tuning the energy inputs into the primary reactant (nitrogen) and the secondary reactant(s) to achieve optimal reactivity and energy consumption.

Advantageously, the secondary reactant can be a hydrogen source reactant or an oxygen source reactant. Examples of hydrogen source molecules have been provided above, including without limitation diatomic hydrogen and hydrocarbon compounds such as methane, other light/gaseous hydrocarbons, or other hydrogen sources including aliphatic or aromatic hydrocarbons, including without limitation alkanes or paraffins of various sizes and structures, such as methane (CH₄), ethane (C₂H₆, CH₃CH₃), propane (C₃H₈), butane (C₄H₁₀)); pentane (C₅H₁₂), hexane (C₆H₁₄), heptane (C₇H₁₆), octane (C₈H₁₈), C₉-C₁₆ alkanes, or heavier molecules, and unsaturated compounds such as alkenes and alkynes, and aromatics. Examples of oxygen source molecules include, without limitation, diatomic oxygen, or other molecules containing an oxygen functional group such as alcohols, glycols, phenols, ethers, aldehydes, ketones, carboxylic acids, epoxides, and esters.

As described above, the systems and methods disclosed herein introduce two separate streams into a nitrogen fixation reactor arranged in a split-stream configuration, with the nitrogen stream being directed into a zone of high field-intensity to create and sustain it as a plasma, while a secondary reactant is shielded from the exposure to high-field intensities. If the secondary reactant is diatomic hydrogen, its combination with the activated nitrogen species produces ammonia. If the secondary reactant is another hydrogen source molecule, its reaction with the plasma-produced activated nitrogen species can result in various nitrogen fixation products in which the activated nitrogen substitutes for one or more hydrogens on the secondary reactant molecule to yield one or more primary, secondary, or tertiary amines. As an example, activated nitrogen as the primary reactant can be combined with methane as a secondary reactant to yield methylamine and ethane in accordance with the reaction shown in the following equation EQ2:

N₂+4CH₄→2NH₂CH₃+C₂H₆ EQ2

In other embodiments, methylamine can be formed by combining activated nitrogen with hydrogen and with methane as secondary reactants in accordance with the reaction shown in the following equation EQ3:

N₂+H₂+2CH₄→2NH₂CH₃ EQ3

In other embodiments, these systems and methods can accomplish nitrogen fixation using methane as a hydrogen source molecule to produce secondary or tertiary amines such as dimethylamine or trimethylamine. Similarly, nitrogen fixation can occur by reacting activated nitrogen with other hydrogen sources and optionally with additional hydrogen to produce higher-order primary, secondary, and tertiary amines or mixtures thereof. As an example, an aromatic hydrogen source molecule such as benzene can be combined with activated nitrogen with added hydrogen to form an amine, for example aniline, as shown in the following equation EQ4:

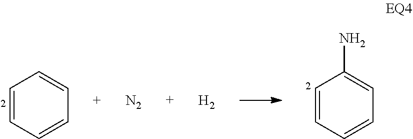 [SMILES: c1ccccc1 ; "N2" ; "+" ; "H2" ; Nc1ccccc1]

Without limitation, those nitrogen fixation reactions using activated nitrogen in combination with hydrogen source molecules fall within the scope of this disclosure, with the production of other primary, secondary, or tertiary amines, or other nitrogenous compounds. If the reaction takes place between nitrogen and hydrogen, ammonia is produced as part of a product stream that includes some unreacted hydrogen and nitrogen. If the reaction is between nitrogen and a more complex hydrogen source molecule, the product stream can include a variety of reaction products derived from the addition or substitution of nitrogen for one or more of the hydrogens in the hydrogen source molecule, and can further include unreacted nitrogen and unreacted hydrogen source molecules. While it is understood that the activated nitrogen species can be inserted in any location along the hydrogen source molecule to form a mixture of desirable and undesirable products, if the secondary reactant is used in an unenergized state, that will tend to limit the number of reactive species interacting with the activated nitrogen, allowing for greater selectivity and higher yield for the desired high-value product(s): since the hydrogen source molecule is not itself energized in the plasma, it has fewer opportunities to form undesired reaction products. In embodiments, the secondary reactant or reactants can also be energized in a separate plasma to form their own activated species, which can then be combined with the activated nitrogen in a designated reaction zone.

If the secondary reactant is an oxygen source molecule, including diatomic oxygen, its reaction with activated nitrogen can result in nitrogen fixation in conjunction with the oxygen molecule or with the oxygen-containing species. For example, activated nitrogen can combine with oxygen to form NOₓ species using the split-stream systems and methods disclosed herein. The NOₓ species can then act as a feedstock for forming nitric acid upon exposure to water, resulting in the overall reaction set forth in the following equation EQ5:

2N₂+5O₂+2H₂O→4HNO₃ EQ5

Subsequent hydration of NOₓ species can also result in the formation of NO, which can be oxidized by O₂ to reform NO₂, which can then be recycled. Controlling the amount of water added to the initially-produced NOₓ can lead to different concentrations of nitric acid, with 68 wt. % being the most common commercial grade. Whether the activated nitrogen species react with a less or more complex secondary reactant (for example, reacting with just hydrogen or oxygen, or reacting with a more complex hydrogen or oxygen source molecule), the resultant product stream can be separated into its components using conventional techniques, e.g., liquefaction, pressure swing adsorption, cryogenic condensation, membrane cartridges, absorption/desorption, and the like, so that the desirable reaction product(s) are separated from the other reaction products and the unreacted species. The separated streams can be commercialized separately, and/or recycled back into the system to optimize utilization of the feedstock.

Not to be bound by theory, it is understood that the inert nature of the triple bonds in diatomic nitrogen renders this molecule relatively resistant to plasma energy if other, more reactive molecules are present: in such a mixture, the other, more reactive molecules are preferentially energized, with insufficient energy then being available to break the nitrogen triple bonds predictably and efficiently. In such mixtures, it has been observed that activated nitrogen species exist in exceedingly low concentrations in the plasma when other, more reactive gases are present in the plasma. Instead, for example in a plasma containing both nitrogen and a secondary reactant, the nitrogen passes through the plasma zone relatively unactivated, because the plasma energy is primarily absorbed by the secondary reactant to create ionic or radical hydrogen species. Under such circumstances, the more reactive plasma component (the secondary reactant) acts as an “energy thief,” becoming activated in the plasma while the nitrogen remains unaffected. Furthermore, the radicals or ions derived from the secondary reactant have insufficient energy to force the relatively inert molecular nitrogen to convert chemically to form ammonia or other desired nitrogenous compounds.

This discovery explains the unsatisfactory performance of conventional NTP systems that attempt to form ammonia or other nitrogenous compounds by energizing mixtures of nitrogen and hydrogen or other hydrogen source molecules. Conventional mixtures of nitrogen and hydrogen or hydrogen sources have been used with NTP plasma to perform nitrogen conversion, but as mentioned previously, these processes have yielded poor results. As described above, it has been unexpectedly discovered that the nitrogen molecule is advantageously activated separately by the plasma in order to form ammonia or other nitrogenous compounds, using a plasma such as a NTP as an energy source, activating the nitrogen molecules in the plasma, and using hydrogen or another hydrogen source molecule as an unenergized secondary reactant to react with the energized nitrogen molecules form the higher-value products.

The discoveries underlying the split-stream plasma technology as disclosed herein are applicable to all such systems that use plasma technologies to combine separately-activated nitrogen with other secondary reactants to form desirable products: only if the nitrogen molecule is present in the plasma as the sole or predominant component without significant “energy theft” from other molecules can it become sufficiently activated in the plasma to break its triple bonds and permit adequate reactivity. Under such advantageous conditions, in the absence of “energy theft” from other molecules, the activated species of nitrogen can then react with other secondary reactant molecules that are brought into contact with these activated species after they have been produced. The triple bond in nitrogen can only be adequately activated when nitrogen is in the plasma alone or in sufficient quantities that essentially the entire applied energy in the plasma is directed at and absorbed by nitrogen.

In accordance with the principles of the invention, nitrogen entering the plasma is separated from any stream of secondary reactants in the same plasma, even if the nitrogen is admixed with other non-reactive gases. However, this restriction does not mean that nitrogen must be the only component in the feed. In certain embodiments, nitrogen can be advantageously combined in a plasma with an inert gas such as helium, neon, or argon to tune the excitation characteristics of the plasma. These co-components in the plasma can facilitate the breakdown of nitrogen by the plasma, as the energetic (but unreactive) noble gas molecules helium, neon, or argon can collide with nitrogen. Yet these co-components are not required for effective plasma-driven nitrogen fixation, because the energized nitrogen alone is sufficient to interact with the unenergized hydrogen to produce ammonia, or to interact with other hydrogen source molecules to produce more complex nitrogenous chemicals, or, in other embodiments, to interact with oxygen to produce NOₓ, or to interact with oxygen source molecules to produce more complex chemicals.

To harness this discovery, systems and methods have been devised as disclosed herein (1) to split the intended reactants into two streams, a primary reactant stream comprising or consisting essentially of the more difficult-to-activate diatomic nitrogen, and a secondary reactant stream that comprises the secondary substance(s) intended to react with the nitrogen; (2) to activate the primary reactant stream in a plasma separately from any activation of the secondary reactant; and (3) to recombine the activated primary reactant with the secondary reactant. In embodiments, the main reactant stream can be introduced into the region of high field intensity to create and sustain a plasma, while the secondary reactant stream is shielded from the high field intensity and is directed to interact in an unactivated state with the activated species of the primary reactant. In other embodiments, the secondary reactant can be passed through a separate high-field environment to create a plasma that activates the secondary reactant as needed to react with activated N₂. This decoupling of the activated N₂ and any activation of secondary reactant(s) increases the tunability of the system to achieve desired selectivities toward the aforementioned products.

In an embodiment, the primary reactant molecule is nitrogen, the secondary reactant is hydrogen, and the product is ammonia. In an embodiment, the primary reactant molecule is nitrogen, the secondary reactant is another hydrogen source (not molecular hydrogen), and the product is an amine. In an embodiment, the primary reactant molecule is nitrogen, the secondary reactant is oxygen, and the product is NOR. In an embodiment, the primary reactant comprises an oxygen functional group, and the product is a nitrogenous compound containing the functionalized oxygen moiety.

In certain of systems and methods described herein, a common feature is the use of the nitrogen-only or nitrogen-predominant feedstock as the source of the activated species for producing reactions; the non-thermal plasma is imposed only on the nitrogen-only or nitrogen-predominant feedstock and not on the secondary reactants. Within the reactor system as a whole, a stoichiometrically advantageous reactant ratio is produced by introducing appropriate quantities of the unactivated secondary reactants, for example, the hydrogen-only or hydrogen-rich source stream that can interact with the activated nitrogen species, or an oxygen-only or oxygen-rich source stream that can interact with the activated nitrogen species. In addition, desirable molecular recombinations involving the activated species and the secondary reactant are facilitated by introducing the secondary reactant into the reactor system at strategic locations and under strategic conditions.

3. Exemplary Reaction Systems and Methods of their Use

Different types of non-thermal plasma reactors can be used to produce the nitrogen plasma used by these systems and methods; the systems and methods for nitrogen fixation as disclosed herein are sufficiently flexible to be used with any desired type of reactor design. Microwave plasmas or radiofrequency plasmas can be used, though such plasmas can require relatively high pressures for optimum utilization, and can be difficult to harness for continuous (as opposed to batch) processing. As an alternative, a dielectric barrier discharge (DBD) system for plasma generation can offer the advantages of continuous operation under atmospheric pressure, with low operating and maintenance costs. To facilitate lower operating temperatures and plasma generation, pressure below atmospheric pressure can be used.

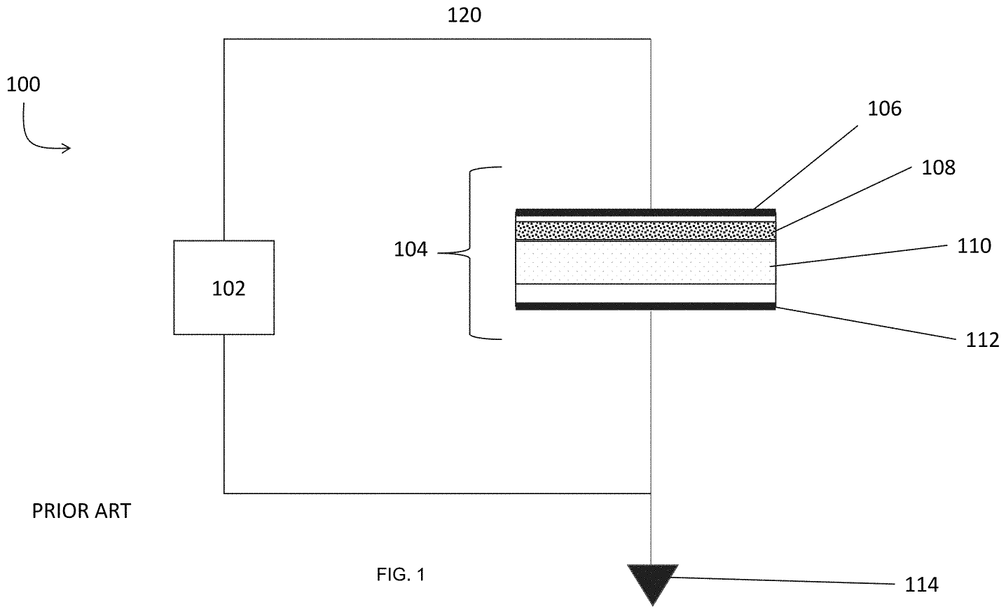

FIG. 1 illustrates schematically the generic components of an exemplary DBD system for plasma generation, as would be familiar to skilled artisans. As shown in FIG. 1, a DBD system 100 includes a power supply 102 and a reactor assembly 104 (shown in cross-section), operatively connected by a circuit 120 and in communication with a ground 114. The power supply provides power to a high voltage electrode 106 (or anode) in the reactor assembly 104, with the ground electrode 112 in the reactor assembly operatively connected to the ground 114. For DBD plasma to be formed, a strong electric field is required. The applied voltage and the distance between the high voltage electrode 106 and the ground electrode 112 determine the strength of the high-energy field that is produced within the reactor region 110; a frequency between 1 KHz and 10 MHz is desirable for generating a DBD plasma. When the electric field is produced, the plasma is generated in the gap between the electrodes. Alternating or direct current can be used in a DBD system.

As shown in this Figure, the high voltage electrode 106 is shielded from the reactor assembly 104 by a dielectric barrier 108, allowing the creation of the high-energy field within the reactor region 110. This high-energy field creates the plasma within the reactor region 110. In embodiments, the reactor region 110 can be formed as a space between the dielectric barrier 108 and the ground electrode 112, for example, if the barrier 108 and the ground electrode 112 are formed as plates, with the high voltage electrode 106 shaped as a plate on top of the dielectric 108. In other embodiments, the reactor region 110 can be formed as a cylinder, with the dielectric barrier 108 surrounding the cylinder, with the high voltage electrode 106 disposed external to the dielectric barrier 108, and with the ground electrode 112 positioned within the cylinder as a coaxial rod. Other arrangements of the components of the reactor assembly 104 will be apparent to artisans of ordinary skill, to permit the generation of the plasma within the reactor region 110 using the DBD system.

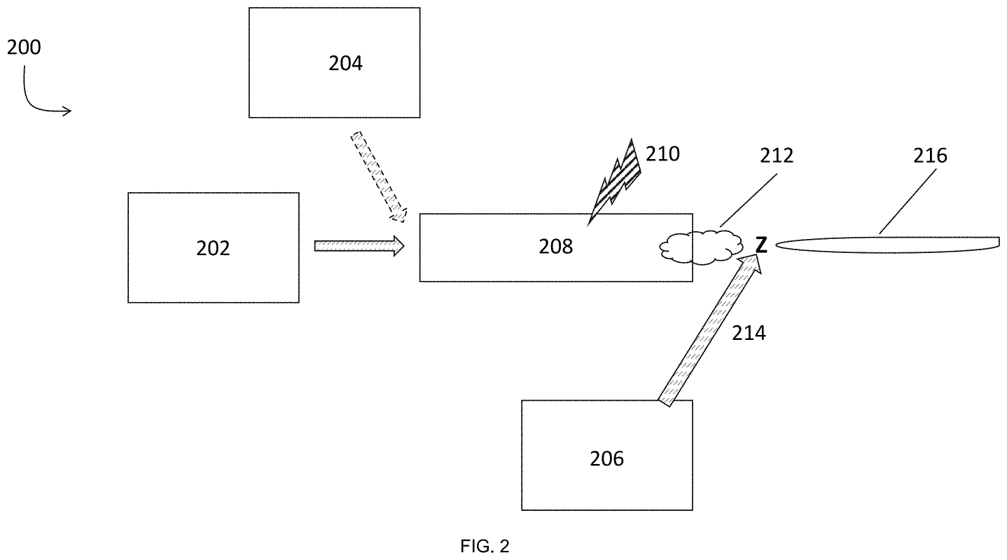

FIG. 2 depicts a block diagram that shows certain features of the systems and methods disclosed herein. FIG. 2 depicts a system 200 for chemical reaction or nitrogen fixation, comprising a nitrogen source 202 that feeds nitrogen gas into a plasma reactor 208 energized by an energy source 210. The nitrogen stream can be accompanied by an optional gas stream 204 comprising gases such as inert or noble gases that can act as co-components to facilitate the breakdown of nitrogen within the plasma chamber 208. As the nitrogen encounters the energy in the plasma reactor 208, it is energized to form a plasma, which exits the plasma reactor 208 as activated nitrogen species 212.

A secondary reactant 214, which can be a hydrogen source compound (including diatomic hydrogen) or an oxygen source compound (including diatomic oxygen) is delivered from a secondary reactant source 206 to interact with the activated nitrogen species 212. The secondary reactant 214 can be delivered through a conduit (not shown) to a designated reaction zone Z, for example where the activated nitrogen species 212 emerge from the plasma reactor 208. As used herein, the term “conduit” can refer to any mechanism, structure, chamber, compartment or region through which a secondary reactant is delivered to a designated area or reaction zone Z where it can interact with the activated nitrogen species 212. The conduit can be a tube, hose, spout, nozzle or the like through which the secondary reactant flows, or it can be a cylinder surrounding or internal to the plasma reactor 208; in other embodiments, where the plasma reactor includes a planar structure such as a plate or where the plasma reactor permits the formation of multiple plasma zones with the interstices of a matrix, the conduit can itself be planar, for example permitting the deployment of the secondary reactant across a flat or shaped surface so that it comes into contact with the energized nitrogen species as either the secondary reactant or the activated nitrogen passes through pores, voids or other channels.

The reaction between the activated nitrogen species 212 and the secondary reactant 214 yields a product stream 216 comprising nitrogen-fixed compounds. For example, if hydrogen is provided as the secondary reactant 214, the hydrogen combines with the activated nitrogen species 212 to form ammonia as the reaction product. While FIG. 2 depicts the collision between the activated nitrogen species 212 and the secondary reactant 214 taking place at the distal end of a plasma reactor 208 as the activated nitrogen 212 exits the plasma reactor, it is understood that the secondary reactant and the activated nitrogen can be directed towards each other at any convenient location for interaction, i.e., in any reaction zone Z, provided that adequate energy of the activated nitrogen species is retained.

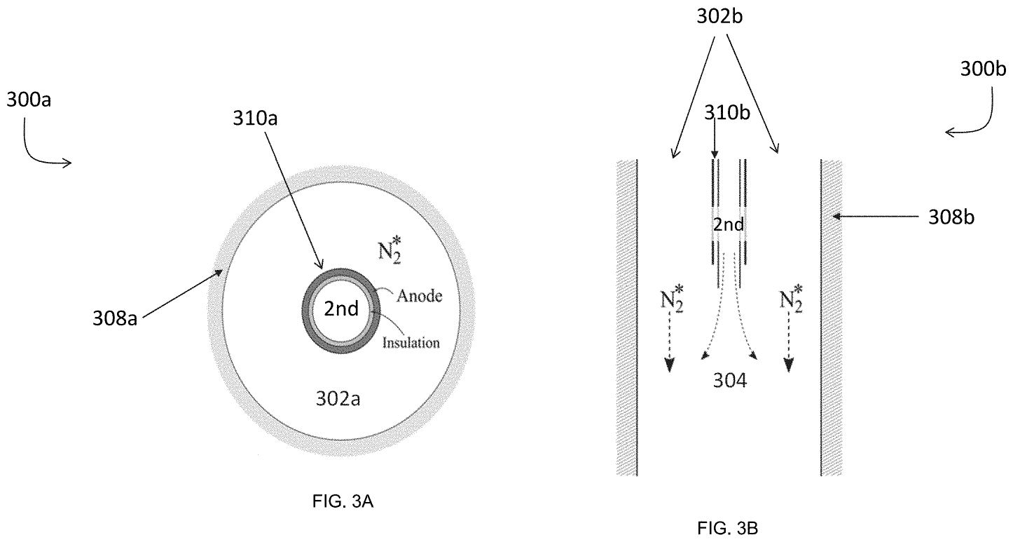

An alternate embodiment is depicted schematically in FIG. 3A and FIG. 3B, which shows systems 300a and 300b in which two conduits are coaxially arranged. The inner conduit (310a and 310b) contains a secondary reactant (designated in the Figures as “2nd”), which can be hydrogen, a hydrogen source molecule, oxygen, or an oxygen source molecule, as previously described. The outer conduit (308a and 308b) conveys the primary reactant nitrogen, designated in the Figures as N₂*. In the depicted embodiment, the conduit 310a or 310b conveying the secondary reactant is maintained within the nitrogen-carrying conduit and is insulated from the plasma-producing energy, while the plasma-producing energy is limited to the structure that confines the nitrogen. i.e., the nitrogen conduit 308a and 308b. In the system shown in FIGS. 3A and 3B, the nitrogen stream and the secondary reactant stream are kept separate from each other. In these Figures, the conduit 310a and 310b containing the secondary reactant stream 2nd is contained within an outer cylinder 308a and 308b that houses the plasma reaction, while being separated and insulated from the plasma produced and confined in the outer cylinder 308a and 308b.

In the system 300a (shown as a cross-section in FIG. 3A), the anode (“Anode”) for the plasma reactor is disposed on the outer aspect of the secondary reactant conduit 310a, creating the field of high energy intensity 302a within the nitrogen-containing cylinder 308a to energize the nitrogen (with activated nitrogen represented by N₂* in this Figure), but with an insulation layer (“Insulation”) disposed internal to the anode and thereby shielding the secondary reactant from the field of high energy intensity. In the aspect of the system 300b shown in longitudinal section in FIG. 3B, the activated nitrogen continues to pass through the nitrogen-containing structure 308b to encounter the unactivated secondary reactant (here hydrogen, a hydrogen source molecule, oxygen, or an oxygen source molecule, with the secondary reactant(s) being represented by “2nd” in this Figure), as the latter emerges from the distal end of its own conduit. Because the anode ends at the end of the secondary reactant conduit, the plasma formation ceases at that level, and the activated nitrogen (produced by the plasma) and the secondary reactant (insulated more proximally from by the plasma) encounter each other in a reaction zone 304 that is not affected by the more proximal area of high plasma energy 302b.

In embodiments, the activated nitrogen species pass into the conduit where the secondary reactant is located; in other embodiments, the activated nitrogen and the secondary reactant can encounter each other through diffusion, whereby the secondary reactant is introduced into a low-energy field that is adjacent to but insulated from the high-energy field where the activated nitrogen is flowing, with the two reactants being separated from each other by a porous barrier that allows passage therethrough. The planar area across which the secondary reactant flows can be termed a “conduit” for this material. In embodiments, the activated nitrogen can pass into the compartment (i.e., a conduit) where the secondary reactant is flowing. In other embodiments, the secondary reactant passes into the compartment where the activated nitrogen species are being or have been generated.

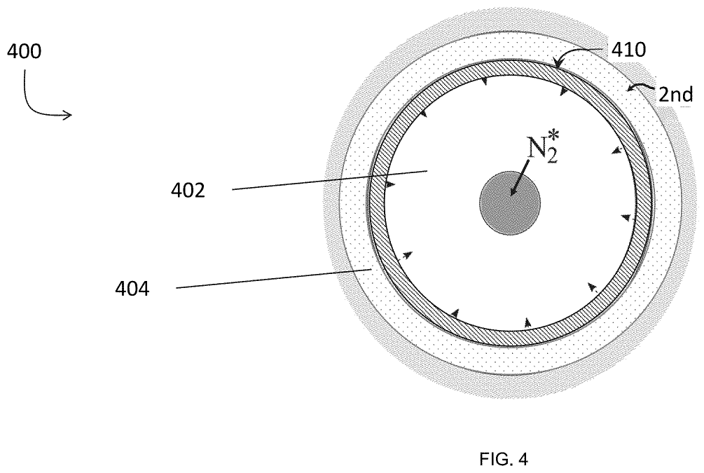

FIG. 4 provides a depiction of such an arrangement. FIG. 4 depicts schematically a cross-section of a system 400 in which the activated nitrogen species N₂* are generated within a central nitrogen conduit 402 that contains the high-energy field, while a secondary reactant (i.e., hydrogen, a hydrogen source molecule, oxygen, or an oxygen source molecule, with the secondary reactant designated by “2nd” in the Figure) flows through a peripheral conduit 404 that partially or completely envelopes the central plasma chamber 402. An insulating but porous wall or membrane 410 isolates the secondary reactant 2nd from contact with the high energy field and separates the secondary reactant 2nd from the activated nitrogen species; however, the porous nature of the wall or membrane 410 allows the influx of the secondary reactant 2nd (which influx is represented by the plurality of small arrows pointing towards and surrounding the central conduit) to contact the activated nitrogen species to the reaction zone outside the plasma zone (not shown), for example at the lower-energy periphery of the plasma zone, where the two reactants commingle and interact, in this case to form ammonia.

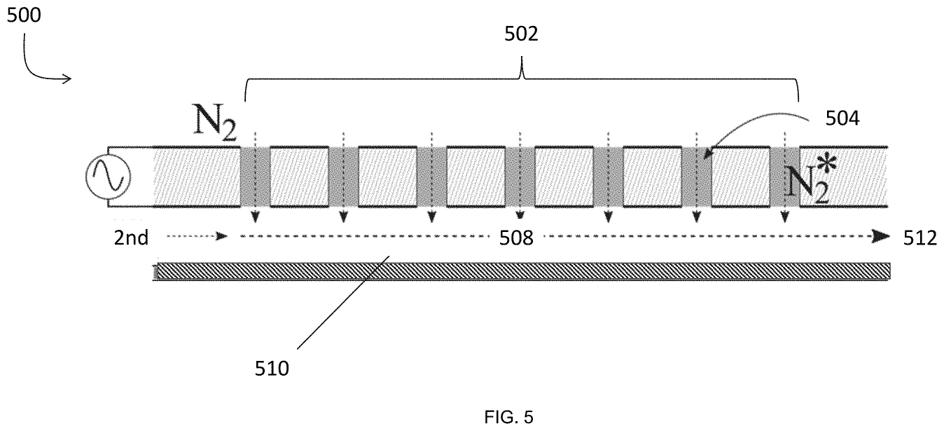

In an alternate embodiment, a series of separate high-energy regions can be created to energize nitrogen gas to form a plasma, for example in an array or a matrix, with the nitrogen being directed into these high-energy regions to be converted into activated nitrogen species N₂*. A representative embodiment is depicted schematically in FIG. 5. As shown in this Figure, a system 500 is shown in cross-section, wherein a flow of nitrogen gas 502 is directed into a plurality of high-energy regions 504 where the nitrogen gas N₂ is formed into a plasma, producing activated nitrogen species N₂*. The activated nitrogen species N₂* emerge from the high-energy regions 504 to encounter a flow 508 of a secondary reactant 2nd, here hydrogen gas, or any other hydrogen source or oxygen source secondary reactant within a secondary reaction conduit 510. The interaction of the N₂* and the hydrogen gas produce the desired product, here ammonia 512, which emerges from the secondary reaction conduit 510 to be separated from any other substances by conventional separation techniques (not shown).

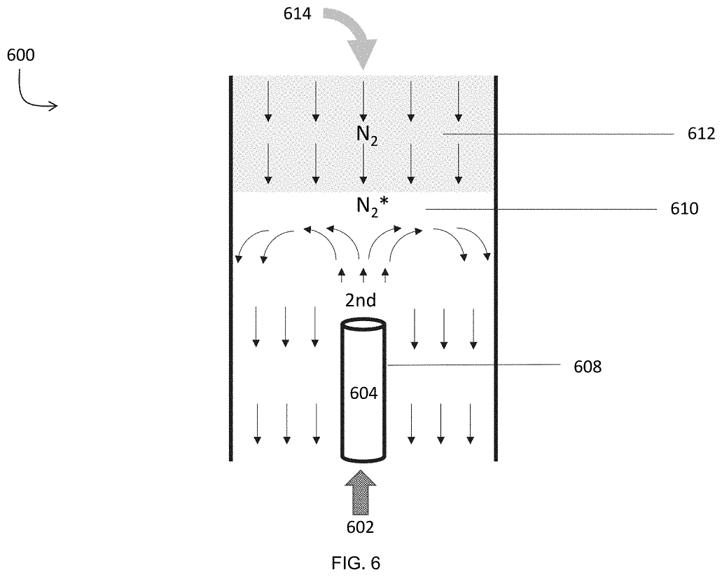

In yet another alternative embodiment, as shown in FIG. 6, a system 600 is shown in cross-section, wherein a flow of a nitrogen-containing source gas 614 is directed into a high-field area 612 in which the nitrogen gas N₂ in the nitrogen-containing source gas is formed into a plasma, producing activated nitrogen species N₂*. In the plasma system 600 depicted in FIG. 6, a feed gas stream 602 comprising one or more secondary reactants in a secondary reactant stream 604 is directed through a secondary reactant injector 608. The stream of secondary reactants 604 for use in the system 600 comprise H₂ and/or a hydrogen source compound (such as ethane, ethylene, propane, or the like, or combinations thereof), or oxygen or an oxygen source compound, as has been described previously in more detail; such secondary reactants (designated in this Figure as “2nd”) enter the reaction zone 610 to encounter the activated nitrogen species N₂* being expelled from the high-field region 612. The gas stream comprising the secondary reactant(s) 604 can also include other, non-reactive gases and/or gases that are not considered secondary reactants. Moreover, while a single feed gas stream 602 is shown entering a single secondary reactant injector 608 to direct a single secondary reactant stream 604 into the reaction zone 610, it is understood that a plurality of secondary gas streams can converge and be mixed in a single secondary reactant injector 608 to produce the single secondary reactant stream 604 contained therein. It is further understood that the secondary reactants 2nd in the reaction zone 610 can be provided by a plurality of secondary reactant injectors, each of which delivers one or more secondary reactants 2nd into the reaction zone 610. In the depicted embodiment, the secondary reactant stream 604 is directed from the secondary reactant injector 608 towards a reaction zone 610, where the secondary reactants 2nd interact with plasma-activated N₂*.

As shown in this Figure, the N₂ * that interacts with the 2nd has been formed from a source gas 614 comprising N₂, where the N₂ entrained in the source gas 614 is energized in the high-field region 612 to form the N₂ *. It is understood that the source gas 614 can comprise other reactive or non-reactive gases, such as, without limitation, helium, neon, argon, and the like. The plasma that energizes the N₂ to produce N₂ * in the high-field region can be produced by any of the plasma-producing methods familiar in the art (e.g., produced by microwaves, radiofrequency, DBD, etc.).

The system 600 is designed so that the N₂ * is directed to encounter the oncoming stream of the secondary reactant 2nd in the reaction zone 610, with the desired product(s) (not shown) being formed in the reaction zone 610 initially by the interaction of the N₂ * and the 2nd. The reaction zone 610 is situated just outside the high-field region 612 between the outflow tract for the 2nd from the secondary reactant injector 608 and the outflow tract for the N₂ * from the high field region. This location of the reaction zone 610, outside the high-field region and between the high-field region 612 and the distal end of the secondary reactor 610, allows products (not shown) to be produced that are not themselves affected by the plasma energy in the high-field region 612. Such products as are formed in the reaction zone 610 can be recovered from this location and can be further separated from each other using conventional separation techniques (not shown), allowing desirable products or their precursors to be isolated for further processing.

The position, diameter, and temperature of the secondary reactant injector 608 as well as the flow rates and direction of the N₂ * and the secondary reactant stream 604 are chosen to achieve a desired flow pattern where the secondary reactant or reactants 2nd do not enter the high-field region 612 but rather encounter the activated N₂ * in the reaction zone 610. Concomitantly, process parameters are selected so that the activated N₂ * does not decay before it can react with the secondary reactant(s) 2nd in the reaction zone. Injector designs for the N₂ and secondary reactant streams can be selected in particular to arrange advantageous flow patterns of the activated N₂ * and the secondary reactants to optimize their interaction with each other, for example vortices or other specially designed flow patterns. For example, an embodiment of a flow pattern is schematically suggested by the arrows in the Figure, but it is understood that other flow patterns can be designed by artisans of ordinary skill using no more than routine experimentation.

In embodiments, various techniques can be used to separate and capture the nitrogen fixation compounds produced by the reactions described herein. Since the processes disclosed herein advantageously create familiar commodity product categories incorporating reduced or oxidized nitrogen, product separation can be conducted using technologies already known in the field of industrial chemistry. In an embodiment, the nitrogen fixation product can be absorbed into a hydrophilic liquid like water, acetone or alcohol, or some other appropriate vehicle for absorption. Absorbing the nitrogen fixation product, for example, ammonia, can limit undesirable back-reactions that could decompose the product into component molecules; such back-reactions are known to occur when reactions take place within a plasma. However, since the techniques disclosed herein produce ammonia outside the plasma reaction zone (i.e., the plasma is just used to activate the nitrogen, with the activated nitrogen reacting with hydrogen in a designated reaction zone peripheral to the plasma to produce ammonia), there may be less need to prevent back-reactions, so that the absorption of the produced ammonia into the aqueous vehicle is less important. As an alternative for recovering the nitrogen fixation product, cryogenic condensation of the product-containing stream can be employed to separate such products, such as ammonia, from unreacted reactants. Using cryogenics to recover ammonia when it is produced by these systems and methods offers the advantage of yielding a pure ammonia in liquid form, instead of an aqueous ammonia solution. With a pure ammonia product (as opposed to an aqueous solution), there is no need for distillation to produce the pure ammonia in a later operation, thus increasing efficiency of the overall operation and saving the energy that would be required for distillation. As another example, unreacted nitrogen, unreacted secondary reactants, and undesirable reaction products can be separated from the intended nitrogen fixation product(s) by standard operations such as PSA (pressure swing adsorption) or membrane cartridges. The separated streams can be recycled back into the system or commercialized separately, as appropriate.

In embodiments, a non-volatile or low-volatility hydrogen-containing substance in liquid form can be directed to contact the nitrogen-predominant plasma or can be injected immediately downstream from the nitrogen-predominant plasma to act as a secondary reactant. The liquid hydrogen source compound can be introduced or injected as a liquid stream, or can be presented to the activated nitrogen species as a pool or a reservoir, or can be atomized into the reaction zone as small droplets, thus increasing the surface area to facilitate contact between the activated species and the secondary reactant. With more complex hydrogen-containing substances as secondary reactants, more complex nitrogen-containing molecules are produced by the nitrogen fixation process, rather than the simple synthesis of ammonia. Conventional separation techniques can be used to separate the various reaction products and to isolate them for commercial uses, for disposal, or for recycling, as applicable. Suitable liquid hydrogen source molecules can be selected to produce specific, desirable products; for example, the liquid hydrogen source molecules can be saturated or unsaturated, aromatic or aliphatic in nature, of all chain lengths and complexities, used individually or in mixtures. Hydrogen source molecules advantageously can be biologically produced (e.g., both plant-derived and animal-derived agricultural oils) as well as petroleum-derived.

Similarly, the systems and methods disclosed herein can be applied to nitrogen fixation using diatomic oxygen as the secondary reactant and NOₓ as the products, it is understood that other oxygen sources can be used to produce other compounds based on the fixation of nitrogen from the nitrogen-predominant plasma. For example, in embodiments, a non-volatile or low-volatility oxygen-containing substance in liquid form can be directed to contact the nitrogen-predominant plasma or can be injected immediately downstream from the nitrogen-predominant plasma to act as a secondary reactant. The liquid oxygen source compound can be introduced or injected as a liquid stream, or can be presented to the activated nitrogen species as a pool or a reservoir, or can be atomized into the reaction zone as small droplets, thus increasing the surface area to facilitate contact between the activated species and the secondary reactant. With more complex oxygen-containing substances as secondary reactants, more complex nitrogen-containing molecules are produced by the nitrogen fixation process, rather than the simple synthesis of NOₓ species. Conventional separation techniques can be used to separate the various reaction products and to isolate them for commercial uses, for disposal, or for recycling, as applicable. Suitable liquid oxygen source molecules can be selected to produce specific, desirable products; for example, the liquid oxygen source molecules can include, without limitation, a variety of oxygen functional groups in the form of alcohols, glycols, phenols, ethers, aldehydes, ketones, epoxides, carboxylic acids, and esters, of all chain lengths and complexities, used individually or in mixtures. Oxygen source molecules advantageously can be biologically produced (e.g., both plant-derived and animal-derived agricultural oils) as well as petroleum-derived.

With reference to ammonia production, it has been recognized that conventional plasma systems for nitrogen fixation do not provide sufficient energy to form ammonia from nitrogen and hydrogen mixtures that are used together as feedstock for the plasma, due to the durability of the nitrogen triple bond; thus, catalysts are required for conventional plasma-assisted ammonia synthesis. Moreover, mixtures of desirable and undesirable reaction products are formed that need to be separated. Catalysts have been employed in conventional plasma-assisted ammonia synthesis both to increase yields and to facilitate separation.

However, the systems and methods disclosed herein proceed without requiring the use of a catalyst, in contrast to the majority of those plasma-based processes offered as lower-energy alternatives to synthetic reactions such as HB. By separating the nitrogen from the secondary hydrogen-donating reactant(s) and energizing the nitrogen selectively, the split-stream plasma systems and methods disclosed herein can concentrate the plasma energy on the nitrogen molecules, yielding activated nitrogen capable of reacting more effectively and efficiently with the hydrogen-donating secondary reactant(s). Thus, using these technologies, catalysts can be avoided. However, despite the advantages to a catalyst-free system, the use of a catalyst can be advantageous under certain circumstances, and catalysts can be optionally employed with the systems and methods disclosed herein. Plasma-assisted nitrogen fixation can thus be carried out using these systems and methods with the inclusion of optional catalysts that are familiar to skilled artisans in the field, in conventional configurations such as powders, wires, whiskers, pellets, and the like.

The embodiments depicted above explicitly embrace using any secondary reactant, whether a hydrogen source or an oxygen source. While hydrogen and oxygen are understood to be advantageous secondary reactants for nitrogen-based reactions performed in accordance with the systems and methods disclosed herein, it is understood that nitrogen fixation can be performed using a full spectrum of hydrogen source molecules and oxygen source molecules. As would be appreciated by artisans of ordinary skill, compounds formed by nitrogen fixation using oxygen or oxygen source molecules (whether diatomic oxygen or more complex molecules comprising oxygen functional groups) have different chemical properties and behaviors than those formed by nitrogen fixation using hydrogen or hydrogen source molecules. Appropriate adjustments of the depicted systems can be performed to optimize the nitrogen fixation processes for different secondary reactants, using no more than routine experimentation.

In addition, secondary reactants can also include other heteroatoms in molecules that can combine with the activated N₂ species to form desirable products. For example, a thiol or other organosulfur compound as a secondary reactant can combine with the activated N₂* species to form more complex sulfur-containing nitrogen fixation products. As another example, secondary reactants containing carboxylic acid groups can be combined with the activated N₂ species to form more complex nitrogen-containing reaction products such as amino acids.

### Examples

The exemplary embodiments are provided below to illustrate more fully the systems and methods disclosed herein.

### Example 1: Coaxial Cylinders with a Dielectric Barrier Discharge (DBD) Reactor

In this Example, two coaxial cylinders can be configured to form a DBD reactor in which the outer electrode is a porous cylinder. This cylinder can form an electrode pair with an inner conductive cylinder, which acts as a counter-electrode. Alternatively, a tightly wrapped wire mesh or the like can be placed next to the exterior surface of the outer cylinder to function as an electrode. An annular interior chamber is positioned between the inner conductive cylinder and the outer cylinder. This coaxial cylinder arrangement is itself enclosed within an outermost chamber.

Nitrogen gas can flow into and through the annular interior chamber and is energized by the electrode pair of the electrode and the counter-electrode. Hydrogen or a hydrogen source secondary reactant can be continuously fed into the outermost chamber to flow therethrough. The secondary reactant can also permeate the pores in the outer cylinder to enter the interior chamber, where it encounters the nitrogen plasma and is immediately consumed to yield ammonia formation via a cascade of reactive steps. Since the field intensity next to the inner cylinder is stronger than the intensity nearer to the outer cylinder, nitrogen can be preferentially decomposed, forming the necessary intermediates for the intended nitrogen fixation reaction. The secondary reactant, its breakdown impeded by the low-field intensity in the pores of the ceramic insulator, can emerge from the cylinder wall and rapidly combines with the activated species prevalent in the annular plasma zone.

The field intensity gradient is governed by the radius ratio of the inner and outer cylinders. In addition, the feed rates of nitrogen and the secondary reactant can be individually tuned by modifying variables such as the operating pressure of the plasma zone and its cross-sectional area, the porosity/wall thickness of the outer cylinder, and the hydrogen chamber pressure. The system design is flexible and can permit optimization, product selectivity and process control. Other modifications can be employed to improve efficiencies or to enhance nitrogen breakdown. For example, nitrogen activation and breakdown can be further expedited by bumps or patterned protrusions on the surface of the inner electrode to accentuate the local field intensity. In embodiments, the inner cylinder surface can be ridged or scalloped (parallel or perpendicular to the direction of gas flow) or wrapped with non-conductors such as glass wool.

### Example 2: Coaxial Cylindrical Electrode Pair with Central Hollow Cylinder Electrode

In this Example, non-porous cylinders can be arranged coaxially. The inner cylinder is a hollow tube to allow flow of the secondary reactant, e.g., hydrogen or a hydrogen source gas. While flowing in the inner cylinder, the flow of this gas is unperturbed. The outer aspect of the inner cylinder can act as an electrode. The annular region between the inner cylinder and the outer cylinder can convey nitrogen therethrough, and can be configured as an electrode pair, with the outer cylinder acting as the counter-electrode to the electrode deployed on the outer aspect of the inner cylinder. The imposed electrical field within the annular region can affect the nitrogen to form a plasma. As an alternative to using a DBD arrangement, a microwave-based system or other plasma generation system can be used to form the plasma within the annular region. As the secondary reactant exits the inner cylinder, it can encounter the activated nitrogen species that have been formed in the plasma. In this region, the desired products (e.g., ammonia) can be formed.

The ends of the inner and outer cylinders can be designed to prevent arcing or field intensification. For example, the inner tube can have a non-conductor section that extends beyond the region defined by the coaxial electrodes. In an embodiment, a hollow metal tube can be tightly fitted with a hollow non-conductor tube inside it to form the inner cylinder assembly. The non-conductor can be longer than the hollow metal tube to extend beyond it. The distance of the extension portion of the non-conductor can be tuned, depending on relative gas flow rates and exact process conditions. Other mechanisms of gas mixing can be introduced in this section to promote collisions of molecules, free radicals, and ions, as desired. As an example, inert packing material (e.g., glass wool) or baffle/agitator designs can be positioned downstream from the distal end of the tube to facilitate mixing the activated species with the secondary reactant.

### Example 3: Parallel Plate Reactor System with Alternating Plasma and Non-Plasma Zones

A system of alternating plasma and non-plasma zones can be arranged in zones using planar geometry. A nitrogen gas (or nitrogen-predominant gas) can be directed through a layered activation zone where it encounters plasma and is activated, and a secondary reactant gas can be directed through an adjacent non-energized layer or zone. As the gases emerge from their respective zones, they can combine to produce the desired products, for example nitrogen and hydrogen combining to produce ammonia. Techniques familiar to skilled artisans can prevent reactor edge arcing and field concentration. This system advantageously allows for expansion simply by stacking additional layers and electrodes. The plasma zones can be sustained by the necessary voltage differential across the two boundary plates, while the non-plasma region can be flanked by plates that remain at the same electrical potential at all times. This design can be tailored for use with AC or DC systems for plasma production; for microwave-generated plasmas, the wave energy can be directed by waveguides to the desired (alternating) channels, for example, using striated waveguides or other designs to direct the wave energy into the desired zones for nitrogen activation.

### Example 4: Nitrogen or Nitrogen-Predominant Plasma Interacting with Hydrogen Source Liquids

In this Example, plasma can be formed from gas phase nitrogen while hydrogen-containing secondary reactants can be used in a liquid state. The nitrogen plasma can be produced using any of the techniques used for plasma generation, and then the energized nitrogen species can encounter the liquid secondary reactants. This encounter can take place within the plasma chamber or external to it. For example, a liquid secondary reactant can be deployed in a pool or as a layer on a surface exterior to the plasma chamber where it can be struck by the energized nitrogen species. Or, for example, a liquid secondary reactant can be atomized into droplets and sprayed into the plasma chamber to interact with the energized nitrogen species therein, or it can be sprayed external to the plasma chamber to be struck by the energized nitrogen species as they exit the plasma chamber. The increased surface area of the sprayed liquid can bring more of the secondary reactants into contact with the energized nitrogen species, enhancing product formation. Liquids such as petroleum-derived oils or agricultural bio-oils can be used as secondary reactants for this exemplary form of treatment. Nitrogen fixation using these secondary reactants can produce polar liquids that can be separated from the secondary reactant feedstock oils for product isolation. In embodiments, atomization techniques can be used to bring the secondary reactant into contact with the energized species derived from the plasma. For example, a polar liquid such as an oil can be atomized into minute droplets and sprayed so that it encounters the activated species from the plasma. The atomization of the liquid results in an increased surface area for this secondary reactant that can facilitate interactions with the active species.

While this invention has been particularly shown and described with references to preferred embodiments thereof, it will be understood by those skilled in the art that various changes in form and details may be made therein without departing from the scope of the invention encompassed by the appended claims.

1. A system for producing a nitrogen fixation reaction product, comprising:
a nitrogen gas source providing nitrogen gas;
a delivery system for the nitrogen gas in fluid communication with the nitrogen gas source, wherein the delivery system delivers the nitrogen gas into a plasma reactor, and wherein the plasma reactor energizes the nitrogen gas as a plasma to produce activated nitrogen species,
a secondary reactant source providing a secondary reactant in a secondary reactant stream that is separated from the nitrogen gas, wherein the secondary reactant stream is directed to contact the activated nitrogen species in a reaction zone, and wherein the contact between the activated nitrogen species and the secondary reactant in the reaction zone produces a reaction that yields the nitrogen fixation product.

2. The system of claim 1, wherein the plasma reactor forms a non-thermal plasma.

3. The system of claim 2, wherein the plasma reactor comprises a dielectric barrier discharge system or a microwave discharge system.

4. The system of claim 1, wherein the plasma reactor is formed as a cylinder having a proximal end and a distal end, and having an inlet at the proximal end in fluid communication with the delivery system and an outlet at the distal end in fluid communication with the reaction zone, and wherein the nitrogen gas enters the inlet, is converted to the activated nitrogen species within the plasma reactor, and exits through the outlet as activated nitrogen species to enter the reaction zone.

5. The system of claim 1, wherein the activated nitrogen species passes through pores in the plasma reactor to enter the reaction zone to contact the secondary reactant therein.

6. The system of claim 1, wherein the secondary reactant is a hydrogen source compound.

7. The system of claim 6, wherein the hydrogen source compound is hydrogen gas.

8. The system of claim 7, wherein the nitrogen fixation product is ammonia.

9. The system of claim 6, wherein the hydrogen source compound is an aliphatic compound.

10. The system of claim 9, wherein the nitrogen fixation product is an amine.

11. The system of claim 1, wherein the secondary reactant is an oxygen source compound.

12. The system of claim 11, wherein the oxygen source compound is diatomic oxygen.

13. The system of claim 11, wherein the nitrogen fixation product comprises nitrogen oxide (NOₓ) species.

14. The system of claim 1, wherein the secondary reactant comprises a non-oxygen heteroatom.

15. The system of claim 14, wherein the non-oxygen heteroatom is sulfur.

16. The system of claim 1, wherein the secondary reactant is a complex secondary reactant.

17. The system of claim 6, wherein the hydrogen source compound is a liquid.

18. The system of claim 17, wherein the liquid is dispensed as an aerosol to contact the activated nitrogen species in the reaction zone.

19. The system of claim 1, wherein the secondary reactant is energized separately and delivered to the reaction area in an activated state.

20. The system of claim 1, wherein the secondary reactant stream is directed through a conduit to contact the activated nitrogen species in the reaction zone.

21. (canceled)

22. (canceled)

23. The system of claim 1, wherein the nitrogen fixation product exits the reaction zone in an effluent fluid stream.

24-27. (canceled)

28. A method of reacting nitrogen gas and a differentially activated secondary reactant to form a nitrogen fixation product, comprising:
providing a nitrogen gas source that produces a nitrogen gas stream comprising nitrogen gas, and providing a secondary reactant source that produces a secondary reactant stream comprising a differentially activated secondary reactant, wherein the nitrogen gas stream and the secondary reactant stream are separated from each other;
providing at least one plasma reactor;
directing the nitrogen gas stream to enter the at least one plasma reactor while remaining separated from the secondary reactant stream;
energizing the nitrogen gas within the at least one plasma reactor to form activated nitrogen species, wherein the nitrogen gas and the activated nitrogen species remain separated from the secondary reactant stream;
entraining the activated nitrogen species in an activated nitrogen stream;
directing the activated nitrogen stream comprising the activated nitrogen species to exit the at least one plasma reactor to enter a reaction zone; and
directing the secondary reactant stream to enter the reaction zone to interact with the activated nitrogen species in the reaction zone, wherein the activated nitrogen species reacts with the differentially activated secondary reactant in the reaction zone, thereby forming the nitrogen fixation product.

29. The method of claim 28, wherein the differentially activated secondary reactant is not activated.

30. The method of claim 28, wherein the differentially activated secondary reactant is activated in a second plasma reactor prior to the step of directing the secondary reactant stream to interact with the activated nitrogen species in the reaction zone.

31. The method of claim 28, wherein the differentially activated secondary reactant consists essentially of diatomic hydrogen.

32. The method of claim 28, wherein the differentially activated secondary reactant comprises oxygen.

33. The method of claim 32, wherein the differentially activated secondary reactant consists essentially of diatomic oxygen.

34. The method of claim 32, wherein the nitrogen fixation product comprises NOₓ species.

35. The method of claim 34, further comprising hydrating the NOₓ species to produce nitric acid.

36. The method of claim 28, further comprising a step of removing the nitrogen fixation product from the reaction zone in an effluent fluid stream.

37. The method of claim 36, wherein the effluent fluid stream is a gaseous stream.

38. The method of claim 36, wherein the effluent fluid stream comprises a gas phase and a liquid phase.

39. The method of claim 36, further comprising a step of separating the nitrogen fixation product from the effluent stream.

40. (canceled)

41. (canceled)

42. A method for producing a nitrogen fixation reaction, comprising:
providing a primary reactant stream comprising N₂;
providing a secondary reactant stream comprising a hydrogen source reactant intended to react with the N₂ in the primary reactant stream;
separating the primary and the secondary reactant streams and maintaining separation between them;
activating the N₂ in the primary reactant stream in a first plasma to form activated N₂;
shielding the hydrogen source reactant from the first plasma to maintain the hydrogen source reactant in a differentially activated state; and
recombining the activated N₂ with the hydrogen source reactant in the differentially activated state, thereby producing the nitrogen fixation reaction.

43. (canceled)
